(19) United States
(12) Patent Application Publication
(10) Pub. No.: US 2008/0275835 A1
(43) Pub. Date: Nov. 6, 2008

(54) METHOD FOR DECISION SUPPORT LICENSING AND MICROPAYMENTS

(76) Inventors: William Murray Stoval, Draper, UT (US); David John Steiner, Kaysville, UT (US); Archie Marsden, West Jordan, UT (US)

Correspondence Address: PATRICK W. RASCHE (12553 - 1000), ARMSTRONG TEASDALE LLP, ONE METROPOLITAN SQUARE, SUITE 2600, ST. LOUIS, MO, 63102-2740, US

(21) Appl. No.: 11/743,253

(22) Filed: May 2, 2007

(51) Int. Cl. G06N 5/02; G06F 17/30; G06Q 50/00

(52) U.S. Cl. 706/47; 705/2; 707/104.1; 707/9; 707/E17.044

(57) ABSTRACT

A method of increasing the quality of healthcare provided by health care professionals is provided. The method includes providing a computer system comprising a server including a database, downloading a decision support system onto the database, the decision support system includes a plurality of sets of rules, and accessing the plurality of sets of rules and paying for access on a usage basis.

### BACKGROUND OF THE INVENTION

This invention relates generally to decision support systems and, more particularly, to methods and systems for increasing revenue from decision support systems.

Generally, decision support systems are computerized systems used for making decisions. Known decision support systems include a series of rules designed to aid the decision process. Generally, decision support systems include many sets of rules designed to analyze specific situations or conditions. It should be understood that purchasers of decision support systems generally do not use all of the sets of rules included in decision support systems. Instead, purchasers generally use those sets of rules relevant to their medical practice. For example, cardiologists may generally use sets of rules designed to analyze cardiac characteristics of patients, but generally, do not use sets of rules relating to diabetes.

Instructions from decision support systems may provide a substantially higher quality of healthcare. Known decision support systems provide additional information to facilitate optimal health care decisions, sometimes based on information that clinicians overlooked, or on information and/or information trends impossible for clinicians to know, resulting in much better health care. Decision support systems are a substantial investment for smaller healthcare groups, so the customer base is generally limited to large integrated delivery networks (IDN) and teaching hospitals that can use many aspects of decision support systems and afford the cost. Because smaller institutions cannot afford the cost and generally use limited aspects of decision support systems, they do not purchase decision support systems. Decreasing the costs of decision support systems for middle and small sized healthcare providers should increase revenue derived from decision support systems and the overall quality of health care.

Known decision support systems may be purchased in one complete software package and individual rules or sets of rules may not be purchased separately. Moreover, known purchasing schemes for decision support systems do not base payment usage bases or account for incorporating new rules into an existing, already purchased, decision support system.

Generally, health care providers purchase decision support systems to improve patient care, but the health care providers do not receive favorable treatment, such as receiving a direct reimbursement for the substantial investment required to secure decision support systems. Moreover, patients are not aware of decision support systems, so they don't know to request decision support when receiving health care.

### BRIEF DESCRIPTION OF THE INVENTION

In one aspect, a method of increasing the quality of healthcare provided by health care professionals is provided. The method includes providing a computer system including a server including a database, downloading a decision support system onto the database, the decision support system comprises a plurality of sets of rules, and accessing the plurality of sets of rules and paying for access on a usage basis.

In another aspect, a system for enhancing revenue of a decision support system is provided. The system includes a computer system including a server including a database containing a decision support system including a plurality of sets of rules, each set of rules corresponds to a treatment for a malady. The server is configured to allow access to each set of rules and to facilitate payment on a usage basis.

In yet another aspect, a computer system is provided. The computer system includes a server including a database, the database containing a decision support system. The server is configured to generate retrospective health care reports that compare a decision support system treatment against an actual treatment.

### BRIEF DESCRIPTION OF THE DRAWINGS

FIG. 1 is a simplified block diagram of a decision support system in accordance with one embodiment of the present invention; and

FIG. 2 is an expanded version block diagram of an example embodiment of a server architecture of the decision support system.

### DETAILED DESCRIPTION OF THE INVENTION

The methods and systems described herein facilitate usage based payment for decision support systems to facilitate enhancing revenue from these systems and minimizing health care provider costs while increasing the quality of health care they provide. The methods and systems described herein are believed to be applicable to many different businesses for increasing access to and reducing decision support system costs. The example embodiment described herein is the medical business. Although the medical business is the example business described herein, the invention is in no way limited to the medical business.

Exemplary embodiments of systems and processes that facilitate integrated network-based electronic verification of decision support system usage and associated costs are described below in detail. The systems and processes facilitate, for example, basing payment for decision support systems on using separate sets of rules of a decision support system without purchasing the entire decision support system package. A technical effect of the systems and processes described herein include at least one of permitting an entity to use only particular sets of rules and not an entire decision support system. More specifically, in the example embodiment, a hospital or other entity that is engaged in the business of providing health care services to patients, utilizes the methods and systems of the example embodiment to economically access at least one decision support system set of rules and provide a better quality of health care.

Costs of accessing decision support systems may be reduced by basing payment for decision support systems on usage. Using any set of rules within the entire decision support system costs a fraction of the total cost of a decision support system. Basing decision support system payment on usage allows smaller health care providers to obtain decision support for their medical practices and increases revenues from decision support systems. Consequently, in the exemplary embodiment, decision support systems are utilized to provide higher quality health care while reducing costs of decision support system access, thus increasing revenues generated from the system. At least some of the parties that may be involved in these systems and processes include medical care facilities, health care professionals and patients. Medical care facilities provide medical services to patients. Health care professionals refers to those individuals involved in administrating care to patients, such as, but not limited to, physicians, nurses, clinicians and pharmacists. Health care professionals determine which rules or sets of rules of the decision support system complement practices and provide medical services in concert with decision support system results. Patients are the individuals requiring medical care.

It should be appreciated that although the example discussed above is from the medical business, decision support systems may be used in any other business or field of endeavor involving economical and critical decisions. However, it should be further appreciated that other businesses or organizations may define a decision support system containing sets of rules tailored to particular businesses.

In one embodiment, a computer program is provided, and the program is embodied on a computer readable medium and utilizes a Structured Query Language (SQL) with a user interface for administration and an interface for standard input and generating reports. In an exemplary embodiment, the system is run on a business-entity intranet. In a further exemplary embodiment, the system is run in a Windows® NT environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independently and separately from other components and processes described herein. Each component and process also can be used in combination with other assembly packages and processes.

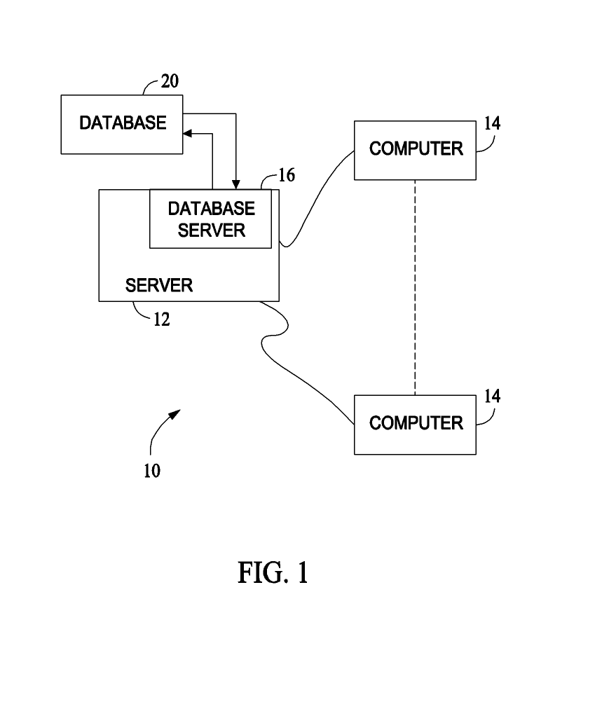

FIG. 1 is a simplified block diagram of a computer system 10 including a server system 12, and a plurality of client sub-systems, also referred to as client systems 14, connected to server system 12. Computerized modeling and grouping tools, as described below in more detail, are stored in server 12 and can be accessed by a requester at any one of computers 14. In one embodiment, client systems 14 are computers including a web browser, such that server system 12 is accessible to client systems 14 using the Internet. Client systems 14 are interconnected to the Internet through many interfaces including a network, such as a local area network (LAN) or a wide area network (WAN), dial-in-connections, cable modems and special high-speed ISDN lines. Client systems 14 could be any device capable of interconnecting to the Internet including a web-based phone, personal digital assistant (PDA), or other web-based connectable equipment. A database server 16 is connected to a database 20 containing information on a variety of matters, as described below in greater detail. In one embodiment, centralized database 20 is stored on server system 12 and can be accessed by potential users at one of client systems 14 by logging onto server system 12 through one of client systems 14. In an alternative embodiment, database 20 is stored remotely from server system 12 and may be non-centralized.

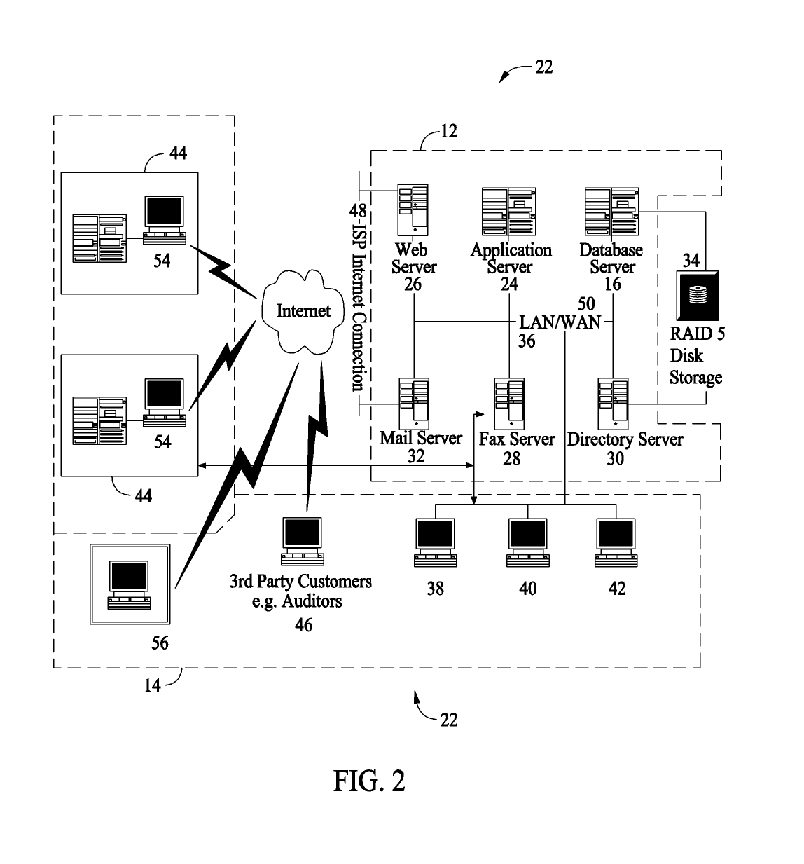

FIG. 2 is an expanded block diagram of an exemplary embodiment of a server architecture of a computer system 22. Components in computer system 22, identical to components of system 10 (shown in FIG. 1), are identified in FIG. 2 using the same reference numerals as used in FIG. 1. Computer system 22 includes server system 12 and client systems 14. Server system 12 further includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator's workstation 38, a user workstation 40, and a supervisor's workstation 42 are coupled to LAN 36. Alternatively, workstations 38, 40, and 42 are coupled to LAN 36 using an Internet link or are connected through an Intranet.

Each workstation, 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

Server system 12 is configured to be communicatively coupled to various individuals, including employees 44 and to third parties, e.g., clients/customers, 46 using an ISP Internet connection 48. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 50, local area network 36 could be used in place of WAN 50.

In the exemplary embodiment, any authorized individual having a workstation 54 can access computer system 22. At least one of the client systems includes a manager workstation 56 located at a remote location. Workstations 54 and 56 are personal computers having a web browser. Also, workstations 54 and 56 are configured to communicate with server system 12.

Furthermore, fax server 28 communicates with remotely located client systems, including a client system 56 using a telephone link. Fax server 28 is configured to communicate with other client systems 38, 40, and 42 as well.

In one exemplary embodiment, decision support systems are installed on a user's computer system 22 at a nominal cost. Systems may be installed using methods, such as, but not limited to, downloading over the internet and installing from a compact disc. That is, the user pays a fee for installing decision support system software, not for the decision support system software itself. More specifically, instead of initially paying for a complete decision support system software package, users elect to pay based on usage of the decision support system. For example, a user may elect to access and use at least one decision support system set of rules and pay a fee for using only that at least one set of rules. It should be understood that the fee is a small fraction of the total decision support system cost. In this exemplary embodiment, users do not have access to other components of the decision support system.

In another alternative exemplary embodiment, users may elect to access all sets of rules of a decision support system, but use only those rules or sets of rules that cover services reimbursable from insurance, or that are requested by a patient. Having access to all rules and sets of rules allows health care providers to provide decision support for non-reimbursable care should a patient request it. For example, when checking a child into a pediatric hospital, health care providers may provide parents the option of having an advanced decision support system package monitor their child while at the hospital in exchange for a nominal fee. Using decision support systems in this alternative exemplary embodiment allows smaller health care providers to reduce decision support system access costs while at the same time increase patient revenue. Moreover, using decision support systems in this alternative exemplary embodiment generates revenue for health care providers by providing a direct link for the health care provider to procure revenue to match against specific uses and related costs of using decision support systems.

In yet another alternative exemplary embodiment, a method of economically using decision support systems allows health care providers to access and use all rules and sets of rules of decision support systems and pay for each instance of use, where the use is dictated by a particular malady and is not dictated by insurance reimbursement policies. That is, whenever the health care provider uses the decision support system, a nominal cost is incurred. Paying for each instance of use allows for a more direct revenue-cost tie-out, so providers only pay for exactly what they use. In this alternative exemplary embodiment, there are little or no initial costs and all of the costs are directly linked to a billable health care service.

Another alternative exemplary embodiment includes a method of economically using decision support system to allow health care providers to access and use rules and sets of rules based on a logical grouping, not necessarily specific sets of rules. For example, all rules relating to a logical grouping, such as, but not limited to, cardiology, could be accessed by a cardiologist. Structuring access by logical grouping allows health care professionals to access rules that are relevant to their specialties and to pay for using only those rules. It should be appreciated that in this alternative exemplary embodiment, access to other rules and sets of rules is not provided.

In a further alternative exemplary embodiment, a method of increasing sales of decision support systems includes free use of a decision support system. More specifically, health care providers may use an entire decision support system for free on a thirty-day trial basis. While using the decision support system for thirty days, health care professionals should realize the benefits of using decision support systems. Consequently, after using the system for thirty days, health care providers should be enticed into concluding that the system is valuable for their practice and, accordingly, should request purchasing an entire decision support system or obtain decision support based on usage.

In yet another alternative exemplary embodiment, a system for enticing health care providers into purchasing decision support systems involves comparing alternative treatments. More specifically, retrospective health care reports are generated after actual treatment has been prescribed that compare a treatment recommended by the decision support system, and associated lower costs, against actual treatment prescribed by a health care professional. In this alternative embodiment the two are compared, and based on the comparison health care providers should determine that using the DSS facilitates lowering health care costs while at the same time improving the quality of health care. Moreover, circumstances where decision support systems should be helpful are monitored and reported to identify the number of times a decision support system would have returned better clinical information than what was prescribed by the health care providers.

It should be understood that in this alternative embodiment, computer systems 22 of health care providers are configured to monitor medications prescribed by health care providers. When a medication is entered into system 22, system 22 displays an alternative less expensive and equally effective treatment on a device, such as but not limited to, a monitor. The message could read “did you realize that you could prescribe Drug X instead which has the same or better efficacy at a cost of $Y less?”. By using the drug prescriptions recommended by the decision support system, the difference in cost between the decision support system prescription and otherwise recommended prescriptions results in substantial cost savings over time. Thus, the savings realized using a particular set of rules may be used to purchase or otherwise pay for that particular set of rules. For example, the savings realized from using the set of rules for antibiotics prescriptions may be used to purchase or otherwise pay for the antibiotics prescriptions set of rules. By tracking the number of times applicable sets of rules could have been used, and determining the amount of money the decision support system would have saved, health care providers are given an economic incentive, or enticement, to purchase at least a particular set of rules or the entire decision support system.

In another alternative exemplary embodiment, health care providers purchase individual rules or sets of rules using systems, such as, but not limited to, the internet. More specifically, health care providers purchase a desired rule or set of rules of the decision support system and directly download the rule or sets of rules to database 20. It should be understood that revisions to the individual components or for the overall system may also be purchased and downloaded to database 20.

In the example embodiments, decision support system revenue generation is enhanced by basing payment on usage and by enticing customers to buy decision support systems. More specifically, by permitting partial use of a decision support system and basing payment on actual usage of the system, smaller health care providers economically access decision support systems and increase the quality of health care they provide. Additionally, health care providers are enticed into purchasing or using the decision support system using free trial runs. As a result, revenue generated by decision support systems increases and the quality of healthcare improves.

While the invention has been described in terms of various specific embodiments, the description of the various embodiments is illustrative only and is not to be construed as limiting the invention. Various other modifications and changes may occur to those skilled in the art without departing from the spirit and scope of the invention.

What is claimed is:

1. A method of increasing the quality of healthcare provided by health care professionals, said method comprising:
providing a computer system comprising a server including a database;
downloading a decision support system onto the database, the decision support system comprises a plurality of sets of rules; and
accessing the plurality of sets of rules and paying for access on a usage basis.

2. A method in accordance with claim 1 wherein paying for access on a usage basis further comprises paying for access on a number of rules accessed.

3. A method in accordance with claim 1 wherein accessing the plurality of sets of rules further comprises accessing at least one of the sets of rules relevant to a specialty of the health care professional.

4. A method in accordance with claim 1 wherein accessing the plurality of sets of rules further comprises accessing only sets of rules relevant to healthcare services reimbursable by health care insurance.

5. A method in accordance with claim 1 wherein accessing the plurality of sets of rules further comprises accessing only sets of rules requested by a patient.

6. A method in accordance with claim 1 wherein paying for access on a usage basis further comprises paying a nominal fee for each instance of using the decision support system, and wherein the nominal fee is a fraction of a total cost of the decision support system.

7. A method in accordance with claim 1 wherein accessing the plurality of sets of rules further comprises accessing sets of rules based on a logical grouping based on a specialty of a health care professional.

8. A method in accordance with claim 1 wherein paying for access on a usage basis further comprises paying for costs directly linked to a billable health service and incurring no initial access costs.

9. A system for enhancing revenue of a decision support system, said system comprising:
a computer system comprising a server including a database containing a decision support system comprising a plurality of sets of rules, each set of rules corresponds to a treatment for a malady, said server configured to allow access to each said set of rules and to facilitate payment on a usage basis.

10. A system in accordance with claim 9 wherein said server is further configured to facilitate payment for access based on a number of rules accessed.

11. A system in accordance with claim 9 wherein said server is further configured to allow access to at least one of said sets of rules relevant to a specialty of a health care provider.

12. A system in accordance with claim 9 wherein said server is further configured to allow access to only said sets of rules relevant to health care services reimbursable by health care insurance.

13. A system in accordance with claim 9 wherein said server is further configured to allow access to only said sets of rules requested by a patient.

14. A system in accordance with claim 9 wherein said server is further configured to allow payment of a nominal fee for each instance of using said decision support system and wherein said nominal fee is a fraction of a total cost of said decision support system.

15. A system in accordance with claim 9 wherein said server is further configured to allow access to said sets of rules based on a logical grouping based on a specialty of a health care professional.

16. A computer system comprising:
a server comprising a database, said database containing a decision support system, said server configured to generate retrospective health care reports that compare a decision support system treatment against an actual treatment.

17. A computer system in accordance with claim 16 wherein said server is further configured to monitor medications prescribed by health care professionals.

18. A computer system in accordance with claim 16 wherein said server is further configured to monitor and report a number of times said decision support system generates an alternative less costly treatment equally effective to a prescribed treatment.

19. A computer system in accordance with claim 18 wherein said server is further configured to generate a message about said alternative less costly treatment and display said message.

20. A computer system in accordance with claim 18 wherein said server is further configured to determine an amount of money saved using said alternative less costly treatments.
